(19) United States
(12) Patent Application Publication
(10) Pub. No.: US 2021/0227901 A1
(43) Pub. Date: Jul. 29, 2021

(54) LEAD GOWN SUPPORT

(71) Applicants: Ghassan S. Kassab, La Jolla, CA (US); Terry A. Hubbard, Valley Center, CA (US)

(72) Inventors: Ghassan S. Kassab, La Jolla, CA (US); Terry A. Hubbard, Valley Center, CA (US)

(21) Appl. No.: 17/157,267

(22) Filed: Jan. 25, 2021

Related U.S. Application Data
(60) Provisional application No. 62/965,157, filed on Jan. 23, 2020.

(51) Int. Cl. A41D 13/12; G21F 3/02

(52) U.S. Cl. CPC A41D 13/129; A41D 13/1245; G21F 3/02

(57) ABSTRACT

A wearable support device for use with heavy clothing is disclosed. The device relieves the shoulders and back of weight by transferring the weight to the waist and hips of the users. The device comprises a frame attached to a waistband. The heavy clothing is worn over the device in a normal fashion. The clothing rests on the frame which, by its construction and by virtue of being rigid and positioned off the torso, transfers the weight to the waistband. An optional cushion is contemplated. Weight supporting posts attached to the waistband are also contemplated.

### PRIORITY

The present patent application is related to, and claims the priority benefit of, U.S Provisional Patent Application Ser. No. 62/965,157, filed on Jan. 23, 2020, the contents of which are hereby incorporated by reference in their entirety into this disclosure.

### BACKGROUND

A number of important medical procedures expose both the patient and the medical team to X-ray radiation. For example, fluoroscopy is an imaging technique that uses relatively high doses of radiation and is used during minimally invasive intravascular procedures to provide live images of the patient. With the aid of fluoroscopy, a team of skilled physicians and nurses can perform life saving procedures such as deploying a stent, applying drugs to a specific area of the patient vasculature, tissue ablation, balloon angioplasty, vessel anastomosis, etc.

Medical personnel participating in the procedure require protective clothing, otherwise the repeated exposure to radiation would be harmful. Thus they wear lead gowns/aprons, among other protective equipment, to mitigate their radiation exposure.

Protective lead clothing can weigh up to and even exceed 17 pounds. Such lead clothing is usually constructed having shoulder straps and a hole for the head so that it may be draped over the torso and rest on the shoulders of the wearer. Thus when in a standing position, the weight of the lead apron is concentrated on the shoulders. When the wearer is leaning slightly forward, such as over an operating table, the weight of the lead clothing is also directed toward the upper back area. The weight and bulk of the lead clothing can throw the wearer off balance and hinder smooth movement. In both positions, the additional weight is uncomfortable and over time becomes quite painful. The repeated use of lead clothing and body positioning leads to chronic injury. Such injuries become permanent disabilities and are career ending for physicians and medical personnel. As a result, these skilled physicians and medical personnel are forced to retire early and are unable to continue treating patients.

Thus there is a need for an improved device that can alleviate the impact of repeated wearing of heavy protective clothing so that such injury can be prevented; thereby extending the career of skilled physicians and allowing them to treat more patients.

### BRIEF SUMMARY

The disclosed embodiments solve the problems mentioned above. The devices transfer weight to a more durable body section, relieving users of significant pain and injury. Exemplary embodiments generally comprise a frame, a waistband and a cushion, that can be worn under a lead gown. In addition, lightweight materials are used in constructing the device to further reduce the weight carried by the user.

The present disclosure includes disclosure of a wearable device for supporting an article disposed onto the device and transferring the weight of the article away from the back and shoulders of the device user towards the larger muscles in the waist and hips.

In an exemplary embodiment, the device comprises: a waistband, a frame attached to the waistband, a cushion attached to the frame, the frame extending from the waistband upward and over the shoulders of a user.

In a further embodiment the cushion is disposed between the frame and the user.

In a further embodiment the frame is attached to the back of the waistband.

In a further embodiment the frame comprises two rigid stays.

In another exemplary embodiment the device comprises a waistband, a frame comprising a vertical portion and a horizontal portion, wherein a first end of the vertical portion is connected to the waistband and second end of the vertical portion is connected to the horizontal portion; and a cushion connected to the frame.

In a further embodiment the cushion is disposed toward the interior of the device.

In one embodiment, a wearable device for supporting an article of clothing disposed thereon comprises a waistband and a frame attached to the waistband; and the frame comprising a rigid material, the frame extending vertically away from the waistband and horizontally over the shoulders of a user, the frame configured to be spaced away from the user.

In one embodiment, a wearable device for supporting an article of clothing disposed thereon comprises a waistband and a frame attached to the waistband; and the frame comprising a rigid material, the frame extending vertically away from the waistband and horizontally over the shoulders of a user, the frame configured to be spaced away from the user and further comprising a cushion disposed toward the interior of the device and positioned on the frame between the frame and the user.

In one embodiment, a wearable device for supporting an article of clothing disposed thereon comprises a waistband and a frame attached to the waistband; and the frame comprising a rigid material, the frame is attached to a rear of the waistband and a second end of the frame is free floating.

In another embodiment of a device for supporting an article of clothing disposed thereon device the frame comprises at least one stay. The at least one stay may comprises a wide and flat shape. In another alternate embodiment, the frame comprises two stays, each of the two stays comprising being attached to a rear of the waistband on opposite sides of a midline of the waistband. The two stays may comprise contours shaped to approximate the form of a human torso.

In one embodiment of a device for supporting an article of clothing disposed thereon, the device can support an article of clothing support up to 17 pounds.

In one embodiment, a wearable device for supporting an article of clothing disposed thereon comprises a waistband; a rigid frame comprising a first vertical portion and a horizontal portion; and the first vertical portion connected to a rear of the waistband at a first end of the first vertical portion, the first vertical portion connected to the horizontal portion at a second end of the first vertical portion, and wherein the first vertical portion extends away from the waistband and the horizontal portion extending toward the front of the waistband.

In one embodiment, a wearable device for supporting an article of clothing disposed thereon, the frame is comprised of a lightweight rigid material comprising one or more of aluminum, carbon fiber, or titanium.

In one embodiment, a wearable device for supporting an article of clothing disposed thereon comprises a waistband; a rigid frame comprising a first vertical portion and a horizontal portion; and the first vertical portion connected to a rear of the waistband at a first end of the first vertical portion, the first vertical portion connected to the horizontal portion at a second end of the first vertical portion, and wherein the first vertical portion extends away from the waistband and the horizontal portion extending toward the front of the waistband; and a second vertical portion attached to the horizontal portion opposite the first vertical portion, the second vertical portion extending toward the waistband.

In one embodiment of a wearable device for supporting an article of clothing disposed thereon the end of the second vertical portion opposite the horizontal portion is free floating.

In one embodiment of a wearable device for supporting an article of clothing disposed thereon the frame is shaped to follow a contour of a human torso.

In one embodiment, a wearable device for supporting an article of clothing disposed thereon, comprises a waistband, a frame attached to the waistband; the frame extending from the waistband upward and over the shoulders of a user, the frame spaced away from the user; and at least one post element, the post element extending from the waistband to a supporting surface, and configured to aid in weight transfer and provide additional weight support.

In alternate embodiments, the post elements may be articulated. The post elements may be disposed on opposite sides of the waistband.

In alternate embodiments, the supporting surface may be a floor or an operating table. In another exemplary embodiment the device comprises a waistband, a frame attached to the waistband, a cushion attached to the frame the frame extending from the waistband upward and over the shoulders of a user; and further comprising two post elements, the post elements extending from the waistband to a supporting surface.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIGS. 1-2 show a wearable support device, according to an exemplary embodiment of the present disclosure; and

FIG. 3 shows another embodiment a wearable support device, according to another exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The terms “lead gown,” “lead apron,” “protective lead clothing,” “protective clothing,” etc. are used interchangeably throughout the specification to refer to heavy clothing worn to protect the user from harmful radiation exposure.

Although the terminology such as “lead gown” or “lead apron” and the above is used, the embodiments within may be used with any heavy protective clothing or even clothing of any weight where it is desired to transfer the load of the clothing away from the shoulders.

Furthermore, it is also envisioned that the embodiments herein may be used generally where it is desired to transfer weight from the shoulders such as, but not limited to, packs, luggage, or any heavy load or item.

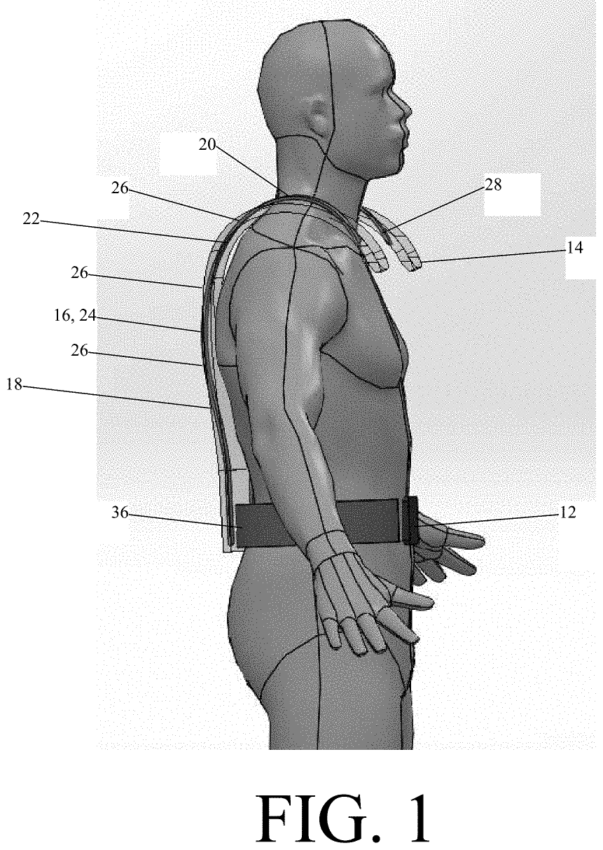

An exemplary device of a lead gown support of the present disclosure is shown in FIG. 1. As shown in FIG. 1, the device comprises a waistband 12, a frame 16 connected to the waistband 12 and a cushion 14 connected to the frame 16.

Now referring to FIG. 1, the waistband 12 is worn around the waist of the wearer. The waistband 12 may be premade to specific dimensions, such as for a custom fit. Preferably, the waistband 12 can be adjustable to be capable of a secure fit and snug fit across a spectrum of wearers. Adjustment may be made manually by adjusting the effective length of the waistband 12, such as through a clasp, or automatically such as by constructing the waistband 12 partially or wholly of elastic material. In the embodiment of FIG. 1 the waistband 12 has a buckle/clasp configured to adjust the waistband 12 length. Where the waistband 12 is configured or adjusted to be snug against the user, this aids in effective transfer of the weight of the lead gown from the shoulders to the waist/hips area of the wearer.

The frame 16 is attached to the waistband 12, and this connection further ensures the effective transfer of the weight of the lead gown away from the wearer's shoulders and back. The frame 16 comprises a generally vertical portion 20 that extends from the waistband 12 upward following the wearer's torso and then further comprises a generally horizontal portion 20 that extends over the shoulder/collarbone of the wearer. Frames 16 may also comprise a transition portion 22 between the generally vertical and generally horizontal portion 20. The transition portion 22 serves the purpose of being contoured to the form of the human shoulders to create a smooth transition between the vertical and horizontal portions 20, rather than a sharp 90 degree angle.

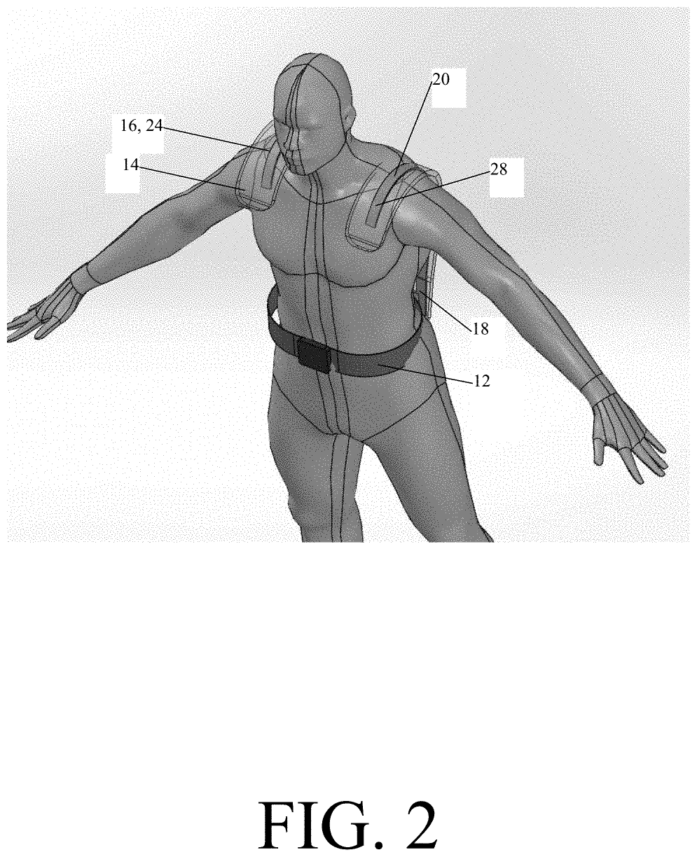

Now referring to FIGS. 1-2, which illustrates an exemplary embodiment, the frame 16 is comprised of two rigid longitudinal stays 24. Each of the two stays 24 are connected at one end to the back/rear 36 of the waistband 12, opposite the buckle 38 and spaced apart so they are bilaterally symmetrical when the embodiment is worn. This has the effect of positioning one stay 24 on each side of a wearer's spine when the lead gown support is worn. The stays 24 comprise a wide and flat shape, being relatively wide when measured across the back of the user and thin or shallow when measured from the front to back of the user. The stays 24 each comprise a generally vertical portion 20 which runs generally parallel along the back of the torso of the wearer in a longitudinal waist-to-head direction. Near the shoulder blade area, the stay 24 begins a transition portion 22, where the vertical portion 20 begins to run in a less vertical direction and into a generally horizontal portion 20. The horizontal portion 20 follows the transition portion 22 and extends over the shoulders/collarbones of the wearer. In the embodiment of FIGS. 1-2, the generally horizontal portion 20 extends into second vertical portion 20 which runs along a length of the front of the torso of the wearer. It is noted that in FIGS. 1-2, the stays 24 comprise contours 26 to follow the general torso shape such as in the lumbar region and in the transition portion 22 over the shoulder region, rather than being strictly 90 degrees to the ground for the generally vertical portion 20 and 180 degrees to the ground for the horizontal portion 20. Furthermore, in the embodiment of FIGS. 1-2 the stays 24 are not resting on the torso or shoulders of the wearer, but are spaced some distance away so as to not cause discomfort and transfer more of the lead gown weight to the hips/waist area.

The function of the frame 16 is to support a heavy lead gown, but it is also a goal of the embodiments herein to reduce the total weight carried by the wearer. Thus the frame 16 is constructed of preferably lightweight material and of such dimensions such that the frame 16 is rigid enough to support lead gown weight, but also lightweight so as to not add to the weight problem. The frame 16 maybe be made of any a suitable lightweight rigid material such as, but not limited to aluminum, titanium, carbon fiber, etc. In a preferred embodiment, the frame 16 or stays 24 are made of aluminum.

Referring again to FIGS. 1-2 an optional cushion 14 is disposed at least partially between the frame 16 and the wearer, thereby preventing the frame 16 from digging into the user and causing pain or injury. The cushion 14 allows the device to be comfortable while being worn. As shown in FIGS. 1-2, the cushion 14 may be integrated with or into the frame 16 while still being disposed toward the interior of the device. A portion of the cushion 14 may also connect to the waistband 12. The cushion 14 may extend beyond the frame/stays 16, 24 in any direction or plane thus being bigger than the frame 16. In a preferred embodiment, the cushion 14 and frame 16 are also positioned such that there is space between the cushion 14 and the body of the wearer so that the cushion ameliorates incidental contact between the device and the wearer during use.

In use the waistband 12 is secured around a wearer and the horizontal portion 20 of the stays 24 positioned over the wearer's shoulders. The waistband is preferably adjusted so as to fit tightly to the wearer. A lead gown (not shown) is worn in a normal fashion and over the device. The gown will rest at least partly on the horizontal portion 20 which is over the shoulders. The weight of the lead gown will be transferred along the generally horizontal component and down the generally vertical component to the waistband 12 where the weight will be shifted to the hips and legs. The muscles in the waist, hips and legs are generally larger, stronger and more durable than the smaller muscles of the upper back and torso. This also has the added benefit of putting less stress on physician arm and hand movement as the shoulders are not as restricted.

Although a device having two bilaterally symmetrical stays 24 is described, the frame 16 may have a variety of shapes as long as it is configured to prevent the weight of the lead gown from resting on the wearer's shoulders and transfer it to the connected portion. i.e. the frame 16 and waistband 12. It is envisioned that the frame 16 could take a variety of shapes. For example, the frame 16 could comprise only one stay 24, or any number of stays 24. The frame 16 could comprise one large stay 24, and the one large stay 24 could be perforated or solid. Instead of only extending partially down the front of the wearer, the frame 16 could extend all the way down the front the wearer and connect to the waistband 12 at both ends. The frame 16 could also extend along the front of the user and/or around the sides. Such variations are within the scope of the invention, and the descriptions herein are not intended to limit said scope.

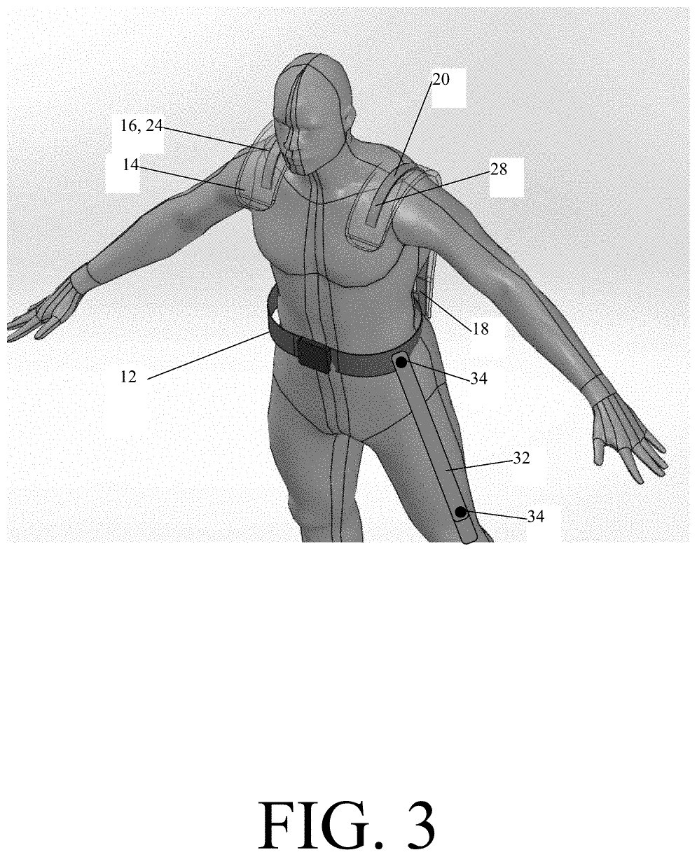

In a further alternate embodiment, the device is substantially as described above, comprising a waistband 12, a frame 16 and a cushion 14, and further comprises two or more post elements connected at a first end to the waistband 12 and at a second end to the ground or floor as shown in FIG. 3. Alternatively the second end may be connected to a load bearing surface, wherein the surface is preferably horizontal. Exemplary support surfaces include, but are not limited to the floor or ground, a wall, an operating table, and any stable structure that may be near locations where a protective gown is worn. The post elements 32 may also be fully articulated, comprising one or more joints 34 positioned on the post element to mirror the joints of a human leg, such as at the knee and/or ankle. The post elements aid in weight transfer and provide additional weight support for a heavy load as described within and may be powered or provide passive support/assistance. Exemplary embodiments include, hydraulic/gas lifts, electric motors, counterweights etc. or combinations of such.

While various embodiments of devices for lead gown support and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A wearable device for supporting an article of clothing disposed thereon, comprising:
a waistband and a frame attached to the waistband; and
the frame comprising a rigid material, the frame extending vertically away from the waistband and horizontally over the shoulders of a user, the frame configured to be spaced away from the user.

2. The device of claim 1 comprising a cushion, wherein the cushion is disposed on the frame and toward the interior of the waistband, between the frame and the user.

3. The device of claim 1 wherein a first end of the frame is attached to a rear of the waistband and a second end of the frame is free floating.

4. The device of claim 1 wherein the frame comprises at least one stay.

5. The device of claim 3 wherein the at least one stay comprises a wide and flat shape.

6. The device of claim 4 wherein the frame comprises two stays, each of the two stays comprising being attached to a rear of the waistband on opposite sides of a midline of the waistband.

7. The device of claim 6 wherein the two stays comprise contours shaped to approximate the form of a human torso.

8. The device of claim 1 wherein the frame is configured to support 17 pounds.

9. A wearable device for supporting an article of clothing disposed thereon, comprising:
a waistband;
a rigid frame comprising a first vertical portion and a horizontal portion; and
the first vertical portion connected to a rear of the waistband at a first end of the first vertical portion, the first vertical portion connected to the horizontal portion at a second end of the first vertical portion, and wherein the first vertical portion extends away from the waistband and the horizontal portion extending toward the front of the waistband.

10. The device of claim 9 further comprising a cushion disposed on the frame facing the interior of the device.

11. The device of claim 9 wherein the frame is comprised of a lightweight rigid material comprising one or more of aluminum, carbon fiber, or titanium.

12. The device of claim 9 wherein the frame further comprises a second vertical portion attached to the horizontal portion opposite the first vertical portion, the second vertical portion extending toward the waistband.

13. The device of claim 9 wherein the frame is shaped to follow a contour of a human torso.

14. The device of claim 12 wherein the end of the second vertical portion opposite the horizontal portion is free floating.

15. A wearable device for supporting an article of clothing disposed thereon, comprising:
a waistband, a frame attached to the waistband;
the frame extending from the waistband upward and over the shoulders of a user, the frame spaced away from the user; and
at least one post element, the post element extending from the waistband to a supporting surface, and configured to aid in weight transfer and provide additional weight support.

16. The device of claim 15 further comprising a cushion disposed on the frame between the frame and the user.

17. The device of claim 15 wherein the post elements are articulated

18. The device of claim 15 wherein the supporting surface is a floor.

19. The device of claim 15 wherein the supporting surface is an operating table.

20. The device of claim 15 wherein the device comprises two post elements disposed on opposite sides of the waistband.
